(19) United States
(12) Patent Application Publication
(10) Pub. No.: US 2006/0178441 A1
(43) Pub. Date: Aug. 10, 2006

(54) Structured surfactant systems

(75) Inventor: John Hawkins, South Staffordshire (GB)

Correspondence Address: Huntsman;Legal Department, Post Office Box 15730, Austin, TX, 78761, US

(73) Assignee: Huntsman International LLC, Salt Lake City, UT (US)

(21) Appl. No.: 10/564,147

(22) PCT Filed: Jul. 14, 2004
(86) PCT No.: PCT/GB04/03051

§ 371 Date: Jan. 10, 2006

(30) Foreign Application Priority Data
Jul. 15, 2003 (GB) 0316467.0
Jul. 24, 2003 (GB) 0317252.5
Aug. 23, 2003 (GB) 0319856.1
Sep. 9, 2003 (GB) 0321036.6
Oct. 31, 2003 (GB) 0325427.3

(51) Int. Cl. B01F 3/12; B01F 17/00; B01F 3/08

(52) U.S. Cl. 516/77; 516/198

(57) ABSTRACT

The invention relates to structured surfactant systems and to suspensions of waterinsoluble, or sparingly soluble, particles therein. In particular it relates to structured systems based on non-ionic and/or zwitterionic surfactants, suitable for applications in which high levels of anionic surfactant are unacceptable.

The invention relates to structured surfactant systems and to suspensions of water-insoluble, or sparingly soluble, particles therein. In particular it relates to structured systems based on non-ionic and/or zwitterionic surfactants, suitable for applications in which high levels of anionic surfactant are unacceptable.

The invention is especially relevant to pharmaceutical and veterinary suspensions, and in particular to aqueous structured surfactant systems capable of suspending water-insoluble pharmaceutical and veterinary active materials for internal use. It is generally suitable for preparations intended for oral administration. Certain compositions according to the invention could also be administered parenterally.

The invention is also especially relevant to food and beverages which comprise a continuous liquid phase with suspended solids

The invention is also especially useful for preparing a variety of industrial suspensions, where high levels of anionic surfactant are undesirable, such as calcium stearate for the cement and paper industries.

The invention is also relevant generally to the suspension of solids or water-immiscible liquids in aqueous, structured-liquid surfactants, for example in cleaning preparations, personal care formulations, agricultural or horticultural applications.

The great majority of medicaments are taken orally, usually in the form of tablets, pills or capsules, despite the fact that many people, especially children and certain dysphagics, have difficulty swallowing them. It is probable that most people would prefer to take medicines in the form of a pleasant tasting liquid, if they were available in such a form. Moreover a pill or capsule can only deliver a fixed dose, and a tablet can only yield a partial dose by cutting, which is usually accompanied by some crushing, resulting in wastage and underdosing. A liquid, in contrast, can be dosed in any amount, to meet the requirements of individual patients.

The main reason why more medicines are not available in liquid form is that the majority are insoluble, or insufficiently soluble, in water or any other acceptable solvent. They could only be made available as suspensions. However medicinal suspensions undergo sedimentation on standing, leading to a risk of under or overdosing, if instructions to shake the bottle thoroughly are not fully complied with. A further problem is that only relatively low concentrations of solids can be suspended, without the product becoming unacceptably viscous. For these reasons the use of suspensions has largely been confined to paediatric medicine. Thus for example suspensions of paracetamol are widely used for treating infants, but no adult equivalent is available.

Sedimentation is also a problem in a variety of food and drink products, including fruit squashes, pulps, purees, preserves and canned fruit and vegetables.

Calcium stearate dispersions have been widely used, for many years, especially in the construction industry, as an additive to cement, to make the set product more water repellent, and also in the paper industry, to provide water repellent coatings to paper. They are also used as lubricants for abrasive coatings. Two long standing problems with such dispersions have been poor physical stability, leading to separation of the solids, and the adverse effect, from the point of view of the end user, of the surfactants, and especially the anionic surfactants, used to improve their stability. Such surfactants have been used as dispersants, to render the particles more hydrophilic, by coating them with a monolayer of surfactant.

Attempts to solve the problem of dispersing solids in water have hitherto involved the use of gums or other polymeric thickeners to raise the viscosity of the liquid medium, or the formation of colloidal dispersions.

Gums and polymeric thickeners, which increase the viscosity of the liquid medium, retard, but do not prevent sedimentation; and at the same time make the composition harder to pour. They do not provide stable suspensions. Thus the paediatric suspensions of paracetamol, although fairly viscous, are not fully stable

Colloidal dispersions contain particles of about 1 micron or smaller, which are prevented from sedimenting by Brownian motion. However there are often problems in preventing the agglomeration, or crystal growth of colloidal particles. Most colloidal suspensions lack long term stability due to Ostwald ripening. For example attempts to provide stable colloidal suspensions of elemental selenium, to remedy dietary deficiencies in grazing animals, have proved unsuccessful.

A further problem with colloidal particles is that, on account of their small size, they tend to dissolve rapidly, releasing the active ingredient within a short period after ingestion, whereas for most treatment regimes a slower, more controlled release is desirable.

An alternative to the above methods of suspension would be the use of a structured suspending system. Structured suspending systems depend on the Theological properties of the suspending medium to immobilise the particles, irrespective of size. This requires the suspending medium to exhibit a yield point, which is higher than the sedimenting or creaming force exerted by the suspended particles, but low enough to enable the medium to flow under externally imposed stresses, such as pouring and stirring, like a normal liquid. The structure reforms sufficiently rapidly to prevent sedimentation, once the agitation caused by the external stress has ceased.

The only structured systems, sufficiently effective to have found widespread application, have been based on surfactant mesophases. These, however, normally require relatively high concentrations of surfactant, usually anionic, and/or electrolyte, which are generally undesirable in medicinal suspensions or beverages, or in cement and a number of other industrial applications. The use of structured surfactants has therefore been largely confined to cleaning preparations, such as laundry detergents and scouring creams.

The term “structured system” as used herein means a pourable composition comprising water, surfactant, any structurants, which may be required to impart suspending properties to the surfactant, and optionally other dissolved matter, which together form a mesophase, or a dispersion of a mesophase in a continuous aqueous medium, and which has the ability to immobilise non-colloidal, water-insoluble particles, while the system is at rest, thereby forming a stable, pourable suspension.

Three main types of structured system have been employed in practice, all involving an Lα-phase, in which bilayers of surfactant are arranged with the hydrophobic part of the molecule on the interior and the hydrophilic part on the exterior of the bilayer (or vice versa). The bilayers lie side by side, e.g. in a parallel or concentric configuration, sometimes separated by aqueous layers. Lα-phases (also known as G-phases) can usually be identified by their characteristic textures under the polarising microscope and/or by x-ray diffraction, which is often able to detect evidence of lamellar symmetry. Such evidence may comprise first, second and sometimes third order peaks with a d-spacing (2π/Q, where Q is the momentum transfer vector) in a simple integral ratio 1:2:3. Other types of symmetry give different ratios, usually non-integral. The d-spacing of the first peak in the series corresponds to the repeat spacing of the bilayer system.

Most surfactants form an Lα-phase either at ambient or at some higher temperature when mixed with water in certain specific proportions. However such conventional Lα-phases do not usually function as structured suspending systems. Useful quantities of solid render them unpourable and smaller amounts tend to sediment.

The main types of structured system used in practice are based on dispersed lamellar, spherulitic and expanded lamellar phases. Dispersed lamellar phases are two phase systems in which the surfactant bilayers are arranged as parallel plates to form domains of Lα-phase, which are interspersed with an aqueous phase to form an opaque gel-like system. They are described in EP 0 086 614.

Spherulitic phases comprise well-defined spheroidal bodies, usually referred to in the art as spherulites, in which surfactant bilayers are arranged as concentric shells. The spherulites usually have a diameter in the range 0.1 to 15 microns and are dispersed in an aqueous phase in the manner of a classical emulsion, but interacting to form a structured system. Spherulitic systems are described in more detail in EP 0 151 884. Many structured systems are intermediate between dispersed lamellar and spherulitic, involving both types of structure. Usually systems having a more spherulitic character are preferred because they tend to have lower viscosity. A variant on the spherulitic system comprises prolate or rod shaped bodies sometimes referred to as batonettes. These are normally too viscous to be of practical interest.

Both of the foregoing systems comprise two phases. Their stability depends on the presence of sufficient dispersed phase to pack the system so that the interaction between the spherulites or other dispersed mesophase domains prevents separation. If the amount of dispersed phase is insufficient, e.g. because there is not enough surfactant or because the surfactant is too soluble in the aqueous phase to form sufficient of a mesophase, the system will undergo separation and cannot be used to suspend solids. Such unstable systems are not “structured” for the purpose of this specification.

A third type of structured system comprises an expanded Lα-phase. It differs from the other two types of structured system in being essentially a single phase, and from conventional Lα-phase in having a wider d-spacing. Conventional Lα-phases, which typically contain 60 to 75% by weight surfactant, have a d-spacing of about 4 to 7 nanometers. Attempts to suspend solids in such phases result in stiff pastes which are either non-pourable, unstable or both. Expanded Lα-phases with d-spacing greater than 8, e.g. 10 to 15 nanometers, form when electrolyte is added to aqueous surfactants at concentrations just below those required to form a normal L_{α}-phase, particularly to surfactants in the H-phase.

The H-phase comprises surfactant molecules arranged to form cylindrical rods of indefinite length. It exhibits hexagonal symmetry and a distinctive texture under the polarising microscope. Typical H-phases have so high a viscosity that they appear to be curdy solids. H-phases near the lower concentration limit (the L₁/H-phase boundary) may be pourable but have a very high viscosity and often a mucous-like appearance. Such systems tend to form expanded Lα-phases particularly readily on addition of sufficient electrolyte.

Expanded Lα-phases are described in more detail in EP 0 530 708. In the absence of suspended matter they are generally translucent, unlike dispersed lamellar or spherulitic phases which are normally opaque. They are optically anisotropic and have shear-dependent viscosity. In this they differ from L₁-phases, which are micellar solutions or microemulsions. L₁-phases are clear, optically isotropic and are usually substantially Newtonian. They are unstructured and cannot suspend solids.

Some L₁-phases exhibit small angle x-ray diffraction spectra which show evidence of hexagonal symmetry and/or exhibit shear dependent viscosity. Such phases usually have concentrations near the L₁/H-phase boundary and may form expanded Lα-phases on addition of electrolyte. However in the absence of any such addition of electrolyte they lack the yield point required to provide suspending properties, and are not, therefore, “structured systems” for the purpose of this specification.

Expanded Lα-phases of the above type are usually less robust than spherulitic systems. They are liable to become unstable at low temperatures. Moreover they frequently exhibit a relatively low yield stress, which may limit the maximum size of particle that can be stably suspended.

Most structured surfactants require the presence of a structurant, as well as surfactant and water in order to form structured systems capable of suspending solids. The term “structurant” is used herein to describe any non-surfactant capable, when dissolved in water, of interacting with surfactant to form or enhance a structured system. It is typically a surfactant-desolubiliser, e.g. an electrolyte. However, certain relatively hydrophobic surfactants such as isopropylamine alkyl benzene sulphonate can form spherulites in water in the absence of electrolyte. Such surfactants are capable of suspending solids in the absence of any structurant, as described in EP 0 414 549. Isopropylamine alkyl benzene sulphonate is not, however, a pharmacologically acceptable surfactant.

A problem with the two phase, especially spherulitic, systems is flocculation of the dispersed surfactant structures. This tends to occur at high surfactant and/or high electrolyte concentration It can have the effect of making the composition very viscous and/or unstable with the dispersed surfactant separating from the aqueous phase.

Certain amphiphilic polymers have been found to act as deflocculants of structured surfactants. One type of deflocculant polymer exhibits cteniform (comb-shaped) architecture with a hydrophilic backbone and hydrophobic side chains or vice versa. A typical example is a random copolymer of acrylic acid and a fatty alkyl acrylate. Cteniform deflocculants have been described in a large number of patents, for example WO-A-9106622.

A more effective type of deflocculant has surfactant (linear) rather than cteniform architecture, with a hydrophilic polymer group attached at one end to a hydrophobic group. Such deflocculants are typically telomers formed by telomerising a hydrophilic monomer with a hydrophobic telogen. Examples of surfactant deflocculants include alkyl thiol polyacrylates and alkyl polyglycosides. Surfactant deflocculants are described in more detail in EP 0 623 670.

WO 01/00788 describes the use of carbohydrates such as sugars and alginates as deflocculants in structured surfactant compositions. The latter comprise surfactant, water and electrolyte in proportions adapted to form flocculated two-phase structured surfactant systems in the absence of the carbohydrate.

The use of deflocculant polymers can give rise to syneresis. The spherulitic suspending medium shrinks in volume leaving a clear portion of the continuous phase external to the spherulitic suspending medium. In conventional, aqueous, structured systems, in which the surfactant is normally less dense than the aqueous phase, this usually manifests itself as a clear lower layer (“bottom separation”). Various auxiliary stabilisers have been suggested to inhibit or prevent syneresis or bottom separation of structured surfactant. For example U.S. Pat. No. 5,602,092 has proposed the use of highly cross linked polyacrylates, while WO 01/00779 describes the use as auxiliary stabiliser of non-cross linked polymers with a hydrophilic back bone and sufficient short (e.g. C₁₋₅) hydrocarbon side chains to enhance physical entanglement of the polymer molecules, e.g. polymers of acrylic acid with ethyl acrylate.

Clays such as bentonite or synthetic layered silicates have also been used as auxiliary stabilisers, either alone or in conjunction with polymers.

The use of deflocculant polymers to prepare clear spherulitic or other dispersed L_{α} structured systems by shrinking the spherulites or other L_{α} domains to a size below the wave length of visible light has been described in WO 00/63079, which also describes the use of sugar to modify the refractive index of the aqueous phase as an alternative means of obtaining clear liquids.

It is known from WO 01/05932 that carbohydrates can interact with surfactants to form suspending structures. Such systems generally exhibit even greater d-spacings than the electrolyte-structured expanded Lα-phases, described in BP 0 530 708. The d-spacings of the sugar-structured systems, described in WO 01/05932, are typically greater than 15 nm, and may, for example, be as high as 50 nm.

In many applications, and especially for pharmacologically acceptable products, and for food and drink, non-ionic surfactants and or zwitterionic surfactants, such as lecithin, are strongly preferred. However structured systems based on non-ionic or zwitterionic surfactants do not readily form stable structured systems, in particular non-ionic surfactants tend to exhibit poor temperature stability at elevated temperatures. They undergo a phase change, on storage under warm conditions, to give non-suspending L₂-phases. WO 01/00780 describes the use of high molecular weight ethoxylates in conjunction with thiocyanates as auxiliary stabilisers inhibiting or preventing loss of structure at elevated temperatures, however thiocyanate is not an acceptable ingredient of products intended for ingestion.

We have now discovered non-ionic and/or zwitterionic based structured surfactant systems with improved temperature stability, which, in a preferred embodiment, are capable of being formulated with pharmacologically acceptable ingredients, and of stably suspending medicaments for internal use.

We have found that structured surfactants formed from non-ionic and/or zwitterionic surfactants having hydrophobic groups with predominantly bent chains are more stable at elevated temperatures than corresponding conventional systems.

As used herein the expression “bent chain” refers to a hydrocarbon chain, which has a dihedral form resulting from the presence of a single non-linear feature, preferably at or near the middle of the chain. Examples of non-linear features include cis-double bonds, short chain (e.g. methyl or ethyl, or less preferably propyl or butyl) branching and carbonyl groups, and also the hydrophilic, “head group” of the surfactant, when the latter is not attached to one end of the chain (i.e. when. the chain is a secondary alkyl group). In contrast, trans-double bonds, or combinations of two or more non-linear features, give chains that are kinked, but are not within the definition of “bent”.

The non-linear group is preferably located at or near the middle of the chain, i.e. at least two, preferably at least three, more preferably at least four, most preferably at least five, carbon atoms from the non-functional end (or, in the case of secondary alkyl groups, ends) of the chain, and preferably also, in the case of primary alkyl or alkenyl groups, from the functional, i.e. hydrophilic end.

According to a first embodiment, the invention provides an aqueous based structured surfactant system, having solid-suspending properties and comprising: water; surfactant, said surfactant consisting essentially of at least one non-ionic and/or zwitterionic surfactant, each comprising at least one hydrophobic group and a non-ionic or zwitterionic hydrophilic group; from 0 to 50%, based on the weight of surfactant, of acids and/or alcohols having a hydrophobic group and a carboxyl or hydroxyl group respectively, and from 0 to saturation of a water-soluble carbohydrate; said surfactant, acid, alcohol, and carbohydrate being present in proportions adapted to form a pourable structured suspending system; characterised in that at least 30% by weight of said hydrophobic groups are bent chain groups.

According to a preferred embodiment, the invention provides a structured surfactant system as aforesaid, for suspending water insoluble pharmaceutical or veterinary active ingredients, which consists essentially of: water; from 0% to saturation of a dissolved carbohydrate; from 0 to 10% by weight, based on the weight of the suspending system, of electrolyte; and from 3 to 10% by weight, based on the weight of the suspending system, of a surfactant mixture consisting of (A) a pharmacologically or veterinarily acceptable surfactant, having an HLB greater than 10, which is preferably an ethoxylated sorbitan ester and (B) a pharmacologically or veterinarily acceptable surfactant, with a HLB less than 10, which is preferably a monoglyceride ester, oleic acid or a phospholipid in a weight ratio of from 10:1 to 1:1, (A):(B).

According to further embodiments, the invention provides a method of suspending pharmaceutical or veterinary active ingredients in a structured surfactant system as aforesaid, and suspensions so formed, and methods of preparing such suspensions in dose form for oral use.

According to a second preferred embodiment, the invention provides a food product or beverage comprising a continuous aqueous liquid phase, and suspended, non-colloidal solid, characterised in that said aqueous phase is a structured surfactant system as aforesaid, which consists essentially of: water, from 25% by weight, based on the weight of the suspending system, to saturation of a dissolved carbohydrate structurant; from 0 to 10% by weight, based on the weight of the suspending system, of electrolyte; and from 3 to 10% by weight, based on the weight of the suspending system, of a surfactant mixture consisting of (A) an edible surfactant, having an HLB greater than 10, which is preferably a ethoxylated sorbitan ester and (B) an edible surfactant, with a pH less than 10, which is preferably a monoglyceride ester or phospholipid, in a weight ratio of from 10:1 to 1:1, (A):(B).

According to a further embodiment, the invention provides a stable, pourable suspension comprising from 10 to 50% by weight of an alkaline earth metal soap suspended in a structured surfactant system as aforesaid, containing from 1 to 5% by weight of surfactant consisting essentially of non-ionic surfactants having a mean HLB of from 9 to 14.

We have further discovered that when the proportion of bent chain hydrophobic groups to straight chain or kinked groups is progressively increased from zero, the electrical conductivity of the freshly prepared compositions typically falls initially, then levels out until about 50% of the hydrophobic groups are bent, before rising to a maximum, usually between 52 and 58% bent groups, and then falling. We have observed that best thermal stability is obtained when the proportion of bent groups is greater than that corresponding to the conductivity maximum. On standing for a few days, the conductivities of the less stable formulations to the left of he maximum tend to increase, to approximately the same value as the maximum, while the conductivities of the more stable formulations to the right of the maximum remain substantially unchanged. The plot then comprises an approximately horizontal portion and a downwardly sloping portion. The former maximum remaining as a well defined turning point

According to a further embodiment, therefore, our invention provides a non-ionic structured surfactant system, in which the proportion of hydrophobic groups, which are bent chain, is greater than that corresponding to the maximum or turning point value in the graph of conductivity of against % bent chain groups.

We have also observed that our preferred suspending systems, containing carbohydrate as structurant, have a substantially higher d-spacing than those of the prior art, and that higher d-spacings, induced by the presence of carbohydrates, correlate with high yield points.

According to a further embodiment, therefore, the invention provides a structured surfactant suspending system, which is preferably an expanded Lα-phase, and which comprises water, a dissolved structurant, which is preferably a carbohydrate, and a surfactant, comprising non-ionic surfactant characterised by a small angle X-ray diffraction peak corresponding to a d-spacing greater than 50 nm.

In the following discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The hydrophobic groups preferably are aliphatic hydrocarbon groups having more than 10, more preferably more than 12, even more preferably more than 14 carbon atoms, but less than 30, more preferably less than 25.

The proportion of bent chain hydrophobic groups is preferably greater than 40%, more preferably greater than 52%, even more preferably greater than 54%, more preferably still, greater than 60%, most preferably greater than 75%, based on the total weight of hydrophobic groups in the surfactant. The preferred bent chain groups are oleyl, erucyl, palmitoleyl, nervonyl and isostearyl.

The total proportion of surfactant is typically between 2 and 35%, preferably greater than 3% more preferably greater than 5%, even more preferably greater than 6% most preferably greater than 7% by weight, based on the total weight of surfactant and water, but preferably less than 30% more preferably less than 20%, even more preferably less than 15%, most preferably less than 10%.

The non-ionic surfactants may typically comprise polyglyceryl fatty esters, fatty acid ethoxylates, fatty acid monoalkanolamides, fatty acid dialkanolamides, fatty acid alkanolamide ethoxylates, propylene glycol monoesters, fatty alcohol propoxylates, alcohol ethoxylates, alkyl phenol ethoxylates, fatty amine alkoxylates and fatty acid glyceryl ester ethoxylates. Other non-ionic compounds suitable for inclusion in compositions of the present invention include mixed ethylene oxide/propylene oxide block copolymers, ethylene glycol monoesters, alkyl polyglycosides, alkyl sugar esters including alkyl sucrose esters and alkyl oligosaccharide esters, sorbitan esters, ethoxylated sorbitan esters, alkyl capped polyvinyl alcohol and alkyl capped polyvinyl pyrrolidone. We particularly prefer surfactants that are approved for pharmacological use.

The surfactants preferably have a mean HLB greater than 6.5, more preferably greater than 7.5, even more preferably greater than 8, more preferably still, greater than 8.5, most preferably greater than 9, but less than 13, more prefer ably less than 12, even more preferably less than 12.5, most preferably less than 11.

It is possible to prepare suspending systems from single surfactants, especially those having an HLB close to 10, such as sorbitan monooleate 5 mole ethoxylate. However, we particularly prefer that the non-ionic surfactant comprises a mixture of at least one relatively high HLB surfactant with at least one relatively low HLB surfactant.

The high HLB surfactant is preferably an ethoxylated sorbitan ester, such as a 10-30 mole, preferably 15-25 mole ethoxy sorbitan monooleate but could alternatively comprise, for example a sucrose or polyglyceryl ester, or ethoxylated castor oil. The ester may be an ester of a C₆₋₂₅, saturated or unsaturated, bent chain fatty acid, such as oleic, erucic or isostearic. It preferably has an HLB greater than 10, more preferably greater than 12, even more preferably greater than 14, most preferably greater than 14.5, but preferably less than 19, more preferably less than 18, most preferably less than 17.

The low HLB surfactant is preferably a monoglyceride ester surfactant, such as glyceryl oleate, or, less preferably, a sorbitan ester, a lactic or acetic acid ester of a monoglyceride or a polyglyceryl ester of a fatty acid. Particularly preferred are esters with C₁₀₋₂₅ bent chain fatty acids such as, oleic, erucic or isostearic. The low HLB surfactant preferably has an HLB less than 8, more preferably less than 7, even more preferably less than 6, most preferably less than 5.5, but preferably greater than 2, more preferably greater than 3, most preferably greater than 3.3.

The weight ratio of low HLB surfactant to high HLB surfactant is preferably less than 2:1, more preferably less than 1.5:1, most preferably less than 1:1, but preferably more than 1:10, more preferably more than 1:5, most preferably more than 1:3.

Zwitterionic surfactants are preferably present in a proportion less than 70%, more preferably less than 50%, most preferably less than 40% by weight of the total surfactant. The preferred zwitterionic surfactants are phospholipids such as lecithin. Lecithin is a diacyl glyceryl phosphato choline

Fatty acids and fatty alcohols are not normally considered to be surfactants, in relation to aqueous systems, because they are water-insoluble On the HLB scale, they are usually rated as 1. However they are soluble in aqueous non-ionic surfactants and have been found to modify the structure forming potential of higher HLB surfactants in an analogous manner to surfactants with an HLB of about 3 to 5. We prefer that they have bent chain hydrophobic groups, preferably with more than 10, more preferably more than 12 most preferably more than 14 carbon atoms, but less than 30, more preferably less than 25, most preferably less then 20 carbon atoms. Preferred examples are oleic, palmitoleic, isostearic and erucic acids. References herein to mixtures of non-ionic surfactants are to be construed, where the context permits, as embracing mixtures of the aforesaid acids and alcohols with non-ionic surfactants.

The surfactant system consists essentially of non-ionic and/or zwitterionic surfactant, together with any fatty acids and/or alcohols. Although minor proportions of anionic, cationic and/or amphoteric surfactant may optionally be present, e.g. up to 30%, by weight, of the total surfactant, for most purposes it is strongly preferred that anionic surfactants in particular, and also cationic surfactants, be substantially absent. If present they preferably constitute les than 15%, more preferably less than 10%, even more preferably less than 5%, more preferably still less than 2%, most preferably less than 1% by weight of the total surfactant

The anionic surfactant, if present may, preferably, comprise an alkyl ether sulphate which is preferably the product obtained by ethoxylating a natural fatty or synthetic C₁₀₋₂₀ e.g. a C₁₂₋₁₄ alcohol with from 1 to 20, preferably 2 to 10 e.g. 3 to 4 ethyleneoxy groups, optionally stripping any unreacted alcohol, reacting the ethoxylated product with a sulphating agent and neutralising the resulting alkyl ether sulphuric acid with a base. The term also includes alkyl glyceryl sulphates, and random or block copolymerised alkyl ethoxy/propoxy sulphates. The anionic surfactant may also comprise, for example, C₁₀₋₂₀ e.g. C₁₂₋₁₈ alkyl sulphate, C₁₀₋₂₀ alkyl benzene sulphonate or a C₈₋₂₀ e.g. C₁₀₋₂₀ aliphatic soap. The soap may be saturated or unsaturated, straight or branched chain. Preferred examples include dodecanoates, myristates, stearates, oleates, linoleates, linolenates, behenates, erucates and palmitates and coconut and tallow soaps. The surfactant may also include other anionic surfactants, such as olefin sulphonates, paraffin sulphonates, taurides, isethionates, ether sulphonates, ether carboxylates, sarcosinates, aliphatic ester sulphonates e.g. alkyl glyceryl sulphonates, sulphosuccinates or sulphosuccinamates.

The cation of any anionic surfactant is typically sodium but may alternatively be potassium, lithium, calcium, magnesium, ammonium, or an alkyl ammonium having up to 6 aliphatic carbon atoms including ethylammonium, isopropylammonium, monoethanolammonium, diethanolammonium, and triethanolainmonium.

Ammonium and othanolammonium salts are generally more soluble than the sodium salts. Mixtures of the above cations may be used.

Preferably the compositions of the invention comprise a carbohydrate. It has been found that, even where the surfactant system is sufficient to form a structured suspending system in the absence of carbohydrate, added carbohydrate tends to increase the yield point and suspending power and stability of the system.

The aqueous structured systems, formed by the interaction of surfactants with carbohydrates, include systems, which are believed to be in the form of an expanded Lα-phase. They include novel systems having an even wider d-spacing than the typical electrolyte-structured expanded Lα-phases described in EP 0 530 708. The systems of the present invention comprise structures, which preferably show d-spacings greater than 20 nm, more preferably greater than 50 nm, even more preferably greater than 51 nm, more preferably still, greater than 70 nm, most preferably greater than 90 nm. Preferably the d-spacing is less than 300 nm, more preferably less than 200 nm, most preferably less than 150 nm.

We do not exclude systems with d-spacings greater than 300 nm, but such d-spacings are difficult to measure accurately, using conventional X-ray diffractometers, due to their proximity to the reference beam. Preferably the above d-spacings relate to the principal, only substantial or sole peak exhibited by the structured system, in the absence of suspended matter, at least above 1 nm.

The discussion is based on the assumption that the structure is lamellar. We do not, however, intend to exclude the possibility that the system may comprise non-lamellar components.

The carbohydrate is preferably a mono or, more preferably, disaccharide sugar, most preferably sucrose, but could for example be fructose, maltose, glucose or invert sugar. Other sugars, which can be used, include, for example, mannose, ribose, galactose, lactose, allose, altrose, talose, gulose, idose, arabinose, xylose, lyxose, erythrose, threose, acrose, rhamnose, fucose, glyceraldehyde, stachyose, agavose and cellobiose. The carbohydrate may be a tri- or tetra-saccharide or, less preferably, a water soluble polysaccharide such as soluble starch, or a water soluble gum.

The term “carbohydrate” as used herein includes water soluble non-surfactant derivatives of carbohydrates such as carboxylic acids and their salts, which can be obtained by oxidising sugars, e.g. gluconic acid, mannic acid, ascorbic acid and alginates, or alcohols obtained by reducing sugars such as sorbitol, mannitol or inositol.

The levels of carbohydrate may be sufficiently high to inhibit microbiological growth in the medium and sufficient to act as an effective biodegradable, non-allergenic preservative for the composition. The carbohydrate may additionally mask the taste of the active ingredient, and render the composition more palatable.

The carbohydrate may be present, optionally, in concentrations up to saturation, preferably greater than 3%, more preferably greater than 5%, even more preferably greater than 10%, most preferably greater than 15% by weight Usually the concentration of carbohydrate is less than 75%, by weight, preferably less than 50%, most preferably less than 40%, by weight.

The composition may optionally contain an electrolyte, in concentrations up to saturation. The concentration of electrolyte is preferably less than 20%, more preferably less than 10%, even more preferably less than 5%, e.g. 0 to 4%, by weight. The electrolyte is typically sodium chloride, but could, for example, alternatively or additionally, be or comprise, sodium carbonate, potassium chloride, sodium phosphate, or sodium citrate. Generally electrolytes may be required in order to form suspending systems, when the concentration of surfactant is too low, and/or its HLB is too high to form a suspending system on its own, and there is not enough carbohydrate present to impose a structure. Usually it is preferred to avoid substantial amounts of electrolyte, unless required to form a stable structure, or perform some other function in the system.

The suspending medium of the invention may be used to suspend any medicament, which is insufficiently soluble in water to be conveniently dosed as an aqueous solution. For example the suspended material may comprise one or more antibiotic, analgesic, antiviral, anthelmintic, antacid, anticonvulsant, antifungal, tranquiliser, sedative, anti-inflammatory, anti-histamine or tonic. It can be used to suspend animal food supplements, such as selenium particles, for veterinary use.

Depending on the yield-point of the suspending medium, the suspended material may have any convenient particle size, and is not limited to micron-sized particles, like colloidal systems. This allows slower release in the body, as well as lower manufacturing costs.

A particular advantage of using structured surfactants to suspend pharmacologically active ingredients is the possibility of suspending particles of widely different sizes, allowing a control over the release rate of the active substance, or the relative release rates of two or more active substances, an effect that has hitherto only been possible using encapsulation.

According to a further embodiment the invention provides a pharmaceutical or veterinary suspension comprising a pharmacologically or veterinarily acceptable structured surfactant and suspended particles of at least one pharmacological or veterinary active substance, said particles comprising at least two populations differentiated with respect to size and including a first population, of non-colloidal particles comprising at least 10%, preferably at least 20%, more preferably at least 30% by weight, based on the total weight of the particles, and a second population of particles comprising at least 10%, preferably at least 20%, more preferably at least 30%, by weight, based on the total weight of the particles, wherein said first population has a mean particle size at least ten times, preferably at least fifty times, more preferably at least 100 times, even more preferably at least 200 times, most preferably at least 500 times the mean particle size of said second population.

Where the invention is used to suspend alkaline earth metal soap, the latter will normally be a calcium soap, although the invention is equally applicable to soaps of other alkaline earth metals such as magnesium, barium, strontium and zinc. The soap is preferably a C₁₀₋₂₅ straight or branched chain, saturated or unsaturated aliphatic soap, but is more preferably straight chain and more preferably saturated. It is particularly preferred that the soap has more than 12, more preferably more than 14, most preferably more than 16 carbon atoms. It is further preferred that the soap has less than 24, more preferably less than 22, most preferably less than 20 carbon atoms. The most widely used soap of this type, by a large margin, is calcium stearate. Other soaps include the alkaline earth metal palmitates, oleates, behenates, arachidates, linoleates and linolenates.

The soap is preferably present in an amount greater than 20%, more preferably greater than 25%, even more preferably greater than 30%, more preferably still, greater than 35%, most preferably greater than 37%, but preferably less than 48%, more preferably less than 45% by weight based on the weight of the suspension.

The total concentration of surfactant, for use in soap suspensions, is preferably less than 5%, more preferably less than 4%, most preferably less than 3.5% by weight, based on the weight of the suspension, but more than 1%, preferably more than 1.5%, most preferably more than 2%.

The suspension may alternatively, for example, be a food or beverage, a detergent, in which the suspended particles may comprise a builder and/or silicone antifoam, a hard surface cleaner comprising a suspended abrasive, a personal care formulation, comprising personal care active ingredients, such as talc, titanium oxide, vegetable oil, silicone oil, exfoliants, pigments and topical medicaments, an agrochemical composition comprising e.g. pesticides, weed-killers or fertilisers or a suspension of seeds or other plant propagules, such as corms, tubers, bulbs, calli or pieces of merristematic tissue for sowing or propagation.

The invention will be illustrated by the following examples, in which all proportions are % by weight unless stated to the contrary.

### EXAMPLE I

A paediatric analgesic suspension comprised:

| | |
|---|---|
| Paracetamol | 2.4 |
| Sorbitan 20 mole ethoxy monooleate | 10 |
| Glyceryl monooleate | 5 |
| Sucrose | 15 |
| Water | balance |

The product was a stable, non-sedimenting suspension. The suspended material had particles ranging in size from 5 to 100μ, compared to a narrow range of about 7μ, which is required to make colloidal dispersions.

### EXAMPLE II

An animal feed supplement comprised:

| | |
|---|---|
| Selenium particles-100mesh (5μ) | 1 |
| Sorbitan 20 mole ethoxy monooleate | 10 |
| Glyceryl monooleate | 5 |
| Sucrose | 15 |
| Water | balance |

The above formulation was a clear thin structured liquid with a d-spacing of about 120 nm, and was stable after three weeks storage

### EXAMPLE III

A fruit drink comprised:

| | |
|---|---|
| Sorbitan monooleate | 1.4 |
| Sucrose monooleate | 4.3 |
| Sucrose | 50 |
| Sodium chloride | 4 |
| Squeezed orange juice | balance |

The product was a stable, non-sedimenting suspension.

### EXAMPLE IV

A composition was prepared consisting of:

| | |
|---|---|
| Oleyl alcohol 6 mole ethoxylate | 2% |
| Lauric acid 9 mole ethoxylate | 1% |
| Calcium stearate | 40% |
| Water | balance |

The mixture was a stable, pourable, spherulitic suspension with good compatibility with cement.

### EXAMPLES V-IX

The following mixtures of surfactants, in equal portions by weight, gave stable spherulitic suspending systems [mean HLB of the mixture in square brackets]:—
V. Glyceryl oleate (HLB3.8)+20 mole polyoxyethylene sorbitan monooleate (HLB 15.0) [9.4]
VI. Polyglyceryl-3-oleate (HLB 7.0)+20 mole polyoxyethylene sorbitan monolaurate (HLB15.0) [11]
VII. Sorbitan oleate (HLB 4.3)+sucrose monolaurate (HLB 16.0) [10.1]
VIII. Tetraglycerol oleate (HLB 6.3)+Decaglycerol oleate (HLB 12.0) [9.1]
IX. Lactic acid ester of monoglyceride (HLB3.5)+20 mole polyoxyethylene sorbitan monooleate (HLB15.0) [9.2]

The blends above were found to produce liquid crystal dispersions at 10% active, 1:1 w/w ratio, in water. Opaque, anisotropic, with Maltese crosses under crossed polarisers.

### EXAMPLE X

Addition of 15 or 30% sucrose to each of examples Example V to IX gave an expanded Lα-phase with higher yield point than the original example, measured on a controlled stress rheometer.

### EXAMPLE XI

A mixture of 3% by weight oleic acid, 12% sorbitan 20 mole ethoxy monooleate gave a stable spherulitic composition. Addition of 15 or 20% sucrose gave a thin Lα-phase with increased yield point.

All the above examples were stable to storage for three weeks at 50° C. Equivalent formulations with stearyl analogues of the oleyl surfactants were unstable under the same conditions.

### EXAMPLE XII

A 1:2 w/w mixture of glyceryl monooleate (molecularly distilled, 90% w/w oleate) and sorbitan 20 mole ethoxy monooleate (78% oleate) and an equivalent mixture of the corresponding stearates, were mixed together in various proportions, at 15% total active weight, and the electrical conductivities were measured. The measurements were repeated on samples with the addition of 15 and 30% sucrose. The results are illustrated in FIG. 1. In each case a peak value is observed at about 54% oleyl.

The measurements were repeated after the samples had stood at room temperature for seven days. The results are illustrated in FIG. 2. In each case the conductivities of all samples to the left of the peak value in FIG. 1 have increased, relative to the peak, while conductivities to the right are relatively unchanged. In each case a turning point can be seen at about 54% oleyl.

Samples of all the above mixtures were stored for two weeks at 40° C. AU samples to the left of the peak, or turning point separated into two layers. All samples to the right of the peak or turning point were stable.

### EXAMPLE XIII

Paracetamol was stably suspended, in amounts up to 20% by weight, in a 15% by weight aqueous solution of sorbitan monooleate 5EO (HLB=10).

1. An aqueous based structured surfactant system, having solid-suspending properties and comprising: water; surfactants, said surfactants consisting essentially of non-ionic and/or zwitterionic surfactants, each comprising at least one hydrophobic group and a non-ionic or zwitterionic hydrophilic group; from 0 to 50%, based on the weight of surfactant, of acids and/or alcohols having a hydrophobic group and a carboxyl or hydroxyl group respectively; and from 0 to saturation of a water-soluble carbohydrate; said surfactant, acid, alcohol, and carbohydrate being present in proportions adapted to form a pourable structured suspending system; characterised in that at least 30% by weight of said hydrophobic groups are bent chain groups.

2. A structured surfactant system according to claim 1 characterised in that the proportion of hydrophobic groups, which are bent chain, is greater than that corresponding to the maximum or turning point value in the graph of conductivity of against % bent chain groups.

3. A structured surfactant system according to claim 1, which is an expanded Lα-phase, and which comprises water, a dissolved carbohydrate, and a non-ionic surfactant characterised by a small angle X-ray diffraction peak corresponding to a d-spacing greater than 50 nm.

4. A structured surfactant system according to claim 1 wherein the hydrophobic groups are aliphatic hydrocarbon groups having more than 10, but less than 30, carbon atoms.

5. A structured surfactant system according to claim 1 wherein the proportion of bent chain hydrophobic groups is greater than 40%.

6. A structured surfactant system according to claim 1 wherein the proportion of bent chain hydrophobic groups is greater than 75%, based on the total weight of hydrophobic groups.

7. A structured surfactant system according to claim 1 wherein the bent chain groups are selected from oleyl, erucyl, palmitoleyl, nervonyl and isostearyl.

8. A structured surfactant system according to claim 1 wherein the total proportion of surfactant is between 2 and 35%.

9. A structured surfactant system according to claim 1 wherein the non-ionic surfactants are selected from polyglyceryl fatty esters, fatty acid ethoxylates, fatty acid monoalkanolamides, fatty acid dialkanolamides, fatty acid alkanolamide ethoxylates, propylene glycol monoesters, fatty alcohol propoxylates, alcohol ethoxylates, alkyl phenol ethoxylates, fatty amine alkoxylates and fatty acid glyceryl ester ethoxylates.

10. A structured surfactant system according to claim 1 wherein the surfactants have a mean HLB greater than 6.5.

11. A structured surfactant system according to claim 1 wherein the surfactants have a mean HLB greater than 9.

12. A structured surfactant system according to claim 1 wherein the surfactant comprises a mixture of at least one relatively high HLB surfactant with at least one relatively low HLB surfactant.

13. A structured surfactant system according to claim 12 wherein the high HLB surfactant has an HLB greater than 10.

14. A structured surfactant system according to claim 12 wherein the high HLB surfactant has an HLB greater than 14.5.

15. A structured surfactant system according to claim 12 wherein the low HLB surfactant has an HLB less than 8.

16. A structured surfactant system according to claim 12 wherein the mixture has a weight ratio of low HLB surfactant to high HLB surfactant of less than 2:1, but more than 1:10.

17. A structured surfactant system according to claim 1, characterised in that zwitterionic surfactants are present in a proportion less than 70%, by weight of the total surfactant.

18. A structured surfactant system according to claim 1, characterised in that the zwitterionic surfactant is lecithin.

19. A structured surfactant system according to claim 1, characterised in that it contains a carbohydrate, which is a mono or disaccharide sugar.

20. A structured surfactant system according to claim 1, characterised in that the carbohydrate is present in a concentration between 15% and 75%, by weight.

21. A structured surfactant system according to claim 1, characterised in that it contains an electrolyte, in concentrations of 0 to 4%, by weight.

22. A structured surfactant system according to claim 1, further comprising a water insoluble pharmaceutical or veterinary active ingredients, which consists essentially of water; from 0% to saturation of a dissolved carbohydrate; from 0 to 10% by weight, based on the weight of the suspending system, of electrolyte; and from 3 to 10% by weight, based on the weight of the suspending system, of a surfactant mixture consisting of (A) a pharmacologically or veterinarily acceptable surfactant, having an HLB greater than 10, and (B) a pharmacologically or veterinarily acceptable surfactant, with a HLB less than 10, oleic acid or a phospholipid in a weight ratio of from 10:1 to 1:1, (A):(B).

23. A structured surfactant system according to claim 1 further comprising suspended particles of at least one pharmacological or veterinary active substance, said particles comprising at least two populations differentiated with respect to size and including a first population, of non-colloidal particles comprising at least 10% based on the total weight of the particles, and a second population of particles comprising at least 10%, based on the total weight of the particles, wherein said first population has a mean particle size at least ten times the mean particle size of said second population.

24. A method of suspending pharmaceutical or veterinary active ingredients comprising:
providing a structured surfactant system, having solid-suspending properties and comprising: water; surfactants, said surfactants consisting essentially of non-ionic and/or zwitterionic surfactants, each comprising at least one hydrophobic group and a non-ionic or zwitterionic hydrophilic group; from 0 to 50%, based on the weight of surfactant, of acids and/or alcohols having a hydrophobic group and a carboxyl or hydroxyl group respectively; and from 0 to saturation of a water-soluble carbohydrate; said surfactant, acid, alcohol, and carbohydrate being present in proportions adapted to form a pourable structured suspending system; characterised in that at least 30% by weight of said hydrophobic groups are bent chain groups;
providing a pharmaceutical or veterinary active ingredient; and
contacting the structured surfactant system and the pharmaceutical or veterinary active ingredient.

25. A suspension formed by the method of claim 24.

26. (canceled)

27. A food product or beverage comprising a continuous aqueous liquid phase, and suspended, non-colloidal solid, characterised in that said aqueous phase is a structured surfactant system having solid-suspending properties and comprising: water; surfactants, said surfactants consisting essentially of non-ionic and/or zwitterionic surfactants, each comprising at least one hydrophobic group and a non-ionic or zwitterionic hydrophilic group; from 0 to 50%, based on the weight of surfactant, of acids and/or alcohols having a hydrophobic group and a carboxyl or hydroxyl group respectively; and from 0 to saturation of a water-soluble carbohydrate; said surfactant, acid, alcohol, and carbohydrate being present in proportions adapted to form a pourable structured suspending system; characterised in that at least 30% by weight of said hydrophobic groups are bent chain groups, which consists essentially of water; from 25% by weight, based on the weight of the suspending system, to saturation of a dissolved carbohydrate structurant; from 0 to 10% by weight, based on the weight of the suspending system, of electrolyte; and from 3 to 10% by weight, based on the weight of the suspending system, of a surfactant mixture consisting of (A) an edible surfactant, having an HLB greater than 10, (B) an edible surfactant, with a pH less than 10, in a weight ratio of from 10:1 to 1:1, (A):(B).

28. A structured surfactant system of claim 1 further comprising an alkaline earth metal soap.

29. A structured surfactant system according to claim 28 wherein the alkaline earth metal soap is calcium stearate.

30. A structured surfactant system according to claim 28, wherein the alkaline earth metal soap is present in an amount greater than 20%, but less than 48% by weight based on the weight of the structured surfactant system.
